(19) United States
(12) Patent Application Publication
(10) Pub. No.: US 2026/0176158 A1
(43) Pub. Date: Jun. 25, 2026

(54) Positive Electrode Material, and Positive Electrod and Lithium Secondary Battery Including the Same

(71) Applicant: LG Energy Solution, Ltd., Seoul (KR)

(72) Inventors: Hyeon Jin Cho, Daejeon (KR); Chi Ho Jo, Daejeon (KR); So Ra Baek, Daejeon (KR); Yeong Deok Yoon, Daejeon (KR); Dong Wan Yoo, Daejeon (KR); Su Yeon Lee, Daejeon (KR)

(73) Assignee: LG Energy Solution, Ltd., Seoul (KR)

(21) Appl. No.: 19/430,526

(22) Filed: Dec. 23, 2025

(30) Foreign Application Priority Data
Dec. 24, 2024 (KR) 10-2024-0196368

(51) Int. Cl. C01G 53/504; H01M 10/052

(52) U.S. Cl. CPC C01G 53/504; H01M 10/052; C01P 2002/88; C01P 2004/61; C01P 2004/84; C01P 2006/37; C01P 2006/40

(57) ABSTRACT

A positive electrode active material includes: a lithium nickel-based oxide having a Ni content of about 60 mol % to 80 mol % among total metals excluding lithium; and a coating layer containing Ti and formed on a surface of the lithium nickel-based oxide. The lithium nickel-based oxide is of a single-particle-type including 50 or fewer nodules and has a thermal stability index (TSI) of about 42.5 or less as represented by Equation 1 according to the present disclosure. In Equation 1, the TSI is represented by “HFA×MPH/(T₁−150),” and HFA, MPH, and Tl are values measured from a differential scanning calorimetry (DSC) analysis graph obtained by heating a lithium secondary battery fabricated using the positive electrode active material from 25° C. to 400° C. at a heating rate of 10° C./min.

### CROSS-REFERENCE TO RELATED APPLICATIONS

This application is based on and claims priority from Korean Patent Application No. 10-2024-0196368 filed on Dec. 24, 2024, with the Korean Intellectual Property Office, the disclosure of which is incorporated herein in its entirety by reference.

### TECHNICAL FIELD

The present disclosure relates to a positive electrode active material, a positive electrode including the positive electrode active material, and a lithium secondary battery including the positive electrode.

### BACKGROUND

Lithium secondary batteries are used in a variety of fields, not only in small products such as digital cameras, power-digital video displays (P-DVDs), MP3 players, mobile phones, personal digital assistants (PDAs), portable game devices, power tools, and E-bikes, but also in large products requiring high output such as electric vehicles and hybrid vehicles, as well as power storage systems configured to store surplus generated power or renewable energy as well as backup power storage systems.

A lithium secondary battery generally includes a positive electrode, a negative electrode, a separator, and an electrolyte, and the positive electrode and the negative electrode include active materials capable of intercalation and deintercalation of lithium ions.

### SUMMARY

The present disclosure provides a positive electrode active material having excellent high-temperature cycle life characteristics and high-temperature storage characteristics, a positive electrode including the positive electrode active material, and a lithium secondary battery including the positive electrode. The positive electrode active material includes a lithium nickel-based oxide having a nickel (Ni) content of about 60 mol % to 80 mol % among total metals excluding lithium and being of a single-particle-type, and a Ti-containing coating layer formed on a surface of the lithium nickel-based oxide, and a thermal stability index (TSI) represented by Equation 1 according to the present disclosure is controlled to 45 or less.

However, the effects covered by the present disclosure are not limited to those mentioned above, and other effects not mentioned will be clearly understood by those ordinarily skilled in the art from the following description.

[1] The present disclosure provides a positive electrode active material including: a lithium nickel-based oxide having a nickel (Ni) content of about 60 mol % to 80 mol % among total metals excluding lithium; and a coating layer containing titanium (Ti) and formed on a surface of the lithium nickel-based oxide. The lithium nickel-based oxide is of a single-particle-type including 50 or fewer nodules, and has a thermal stability index (TSI) of about 42.5 or less as represented by Equation 1 below.

$$Thermal stability index ( TSI ) = HFA \times MPH / ( {T}_{1} - 150 ) \qquad [ Equation 1 ]$$

In Equation 1, HFA, MPH, and T₁ are values measured from a differential scanning calorimetry (DSC) analysis graph obtained by heating a lithium secondary battery fabricated using the positive electrode active material from 25° C. to 400° C. at a heating rate of 10° C./min. HFA is an area value between 150° C. and 350° C. in the DSC analysis graph, MPH is a value of a maximum peak height in the DSC analysis graph, and T₁ is a value of a maximum peak temperature in the DSC analysis graph.

[2] In [1], the thermal stability index (TSI) represented by Equation 1 may be about 30.0 to 38.7.

[3] In [1] or [2], HFA of Equation 1 may be about 300 to 475.

[4] In at least one of [1] to [3], MPH in Equation 1 may be about 5 to 15.

[5] In at least one of [1] to [4], T₁ in Equation 1 may be about 220 to 260.

[6] In at least one of [1] to [5], the lithium nickel-based oxide may be represented by Formula 1 below.

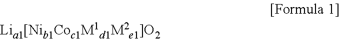

In Formula 1, M¹ is Mn, Al, or a combination thereof, M² includes one or more elements selected from Ti, Mg, Al, Zr, Y, Ba, Ca, Sr, W, Ta, Nb, and Mo, and a1, b1, c1, d1, and e1 satisfy 0.80≤a1≤1.20, 0.60≤b1≤0.80, 0<c1≤0.20, 0<d1≤0.40, and 0≤e1≤0.10.

[7] In at least one of [1] to [6], the lithium nickel-based oxide may include, as dopant elements, two or more elements selected from Zr, Y, Al, W, Nb, and Sr.

[8] In at least one of [1] to [7], the lithium nickel-based oxide may include dopant elements, and a content of the dopant elements may be about 1,000 ppm to 15,000 ppm based on a total weight of the positive electrode active material.

[9] In at least one of [1] to [8], the lithium nickel-based oxide may include, based on a total weight of the positive electrode active material, two or more elements selected from about 500 ppm to 5,000 ppm of Zr, about 500 ppm to 5,000 ppm of Y, about 500 ppm to 5,000 ppm of Al, about 500 ppm to 5,000 ppm of W, about 500 ppm to 5,000 ppm of Nb, and about 500 ppm to 5,000 ppm of Sr.

[10] In at least one of [1] to [9], the coating layer may further include one or more elements selected from Al and W.

[11] In at least one of [1] to [10], the coating layer may have a weight of about 2,000 ppm to 5,000 ppm based on a total weight of the positive electrode active material.

[12] In at least one of [1] to [11], the coating layer may include about 500 ppm to 3,000 ppm of titanium (Ti) based on a total weight of the positive electrode active material, and may further include one or more elements selected from about 500 ppm to 3,000 ppm of aluminum (Al), and about 500 ppm to 3,000 ppm of tungsten (W) based on the total weight of the positive electrode active material.

[13] In at least one of [1] to [12], the positive electrode active material may have an average particle diameter of about 2 μm to 5 μm.

[14] The present disclosure provides a positive electrode including the positive electrode active material according to at least one of [1] to [13].

[15] The present disclosure provides a lithium secondary battery including the positive electrode of [14], a negative electrode disposed to face the positive electrode, and an electrolyte.

The positive electrode active material according to the present disclosure has a Ni content of about 60 mol % to 80 mol % among total metals excluding lithium, and includes a coating layer containing Ti and formed on a surface of a single-particle-type lithium nickel-based oxide. The thermal stability index (TSI) represented by Equation 1 according to the present disclosure is controlled to be about 42.5 or less. As a result, a lithium secondary battery having excellent thermal stability and superior high-temperature cycle life characteristics and high-temperature storage characteristics may be implemented.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is a schematic view illustrating a structure of a positive electrode according to an embodiment of the present disclosure.

FIG. 2 is a schematic view illustrating a structure of a lithium secondary battery according to an embodiment of the present disclosure.

FIG. 3 is a graph illustrating factors MFA, MPH, and T1 of Equation 1 according to the present disclosure.

FIG. 4 is a differential scanning calorimetry (DSC) analysis graph of lithium secondary batteries fabricated in Examples 1 to 3 and Comparative Examples 1 to 4.

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

The terms or words used in the specification and claims should not be construed as limited to their ordinary or dictionary meanings, but should be construed as having meanings and concepts consistent with the technical concept of the present disclosure based on the principle that an inventor may appropriately define the concepts of terms in order to explain the inventor's own invention in the best manner.

The terms used in the present disclosure are used only for the purpose of describing illustrative embodiments and are not intended to limit the present disclosure. Singular expressions include plural expressions unless the context clearly indicates otherwise.

As used herein, terms such as “include,” “comprise,” or “have” are intended to specify the presence of stated features, numbers, steps, components, or combinations thereof, but are to be understood as not precluding the possibility of the presence or addition of one or more other features, numbers, steps, components, or combinations thereof.

In the present disclosure, the term “single-particle-type” refers to a particle formed by aggregation of 50 or fewer sub-particles. A sub-particle unit constituting the single-particle-type particle is referred to as a “nodule.” The single-particle-type particle includes a single particle composed of one nodule and a pseudo-single particle composed of a composite of two to fifty nodules.

The term “nodule” refers to a sub-particle unit constituting a single particle or a pseudo-single particle, which may be either a single crystal having no crystalline grain boundary or a polycrystal in which grain boundaries are not visually observed at a magnification of about 5,000× to 20,000× using a scanning electron microscope.

As used herein, the term “secondary particle” refers to a particle formed by aggregation of more than 50 sub-particles. To distinguish from the sub-particles constituting the single-particle-type particle, sub-particles constituting the secondary particle are referred to as “primary particles.”

In the present disclosure, the term “particle” is a concept including any one or all of a single particle, a quasi-single particle, a primary particle, a nodule, and a secondary particle.

As used herein, the term “BET specific surface area” refers to a value measured by the BET method, and may be calculated specifically from a nitrogen gas adsorption amount at a liquid nitrogen temperature (77 K) using, for example, BELSORP-mino II available from BEL Japan.

As used herein, the term “average particle diameter” refers to a particle size (D₅₀) at a 50% volume cumulative amount in a volume cumulative particle size distribution of a powder to be measured. The average particle diameter may be measured using a laser diffraction method. The laser diffraction method is generally capable of measuring particle sizes ranging from a submicron region to several millimeters and capable of obtaining results with high reproducibility and high resolution. For example, after dispersing the powder to be measured in a dispersion medium, the powder may be introduced into a commercially available laser diffraction particle size analyzer (e.g., Microtrac MT 3000), and irradiated with ultrasonic waves at about 28 kHz with an output of 60 W. Thereafter, a volume cumulative particle size distribution graph is obtained, and the particle size corresponding to 50% of the cumulative volume is determined, thereby measuring the average particle diameter D₅₀.

As used herein, the terms “about,” “approximately,” and “substantially” are used to mean a range of the numerical value or degree, or a value close thereto, in consideration of inherent manufacturing and material tolerances (e.g., ±5%).

As for the positive electrode active materials for a lithium secondary battery, lithium cobalt oxide (LiCoO₂), lithium nickel oxide (LiNiO₂), lithium manganese oxide (e.g., LiMnO₂ or LiMn₂O₄), and lithium iron phosphate compound (LiFePO₄) have been used. Among these, lithium cobalt oxide has advantages such as a high operating voltage and excellent capacity characteristics. However, cobalt, which is a raw material, is expensive and has an unstable supply, making it difficult to apply lithium cobalt oxide commercially to high-capacity batteries. Lithium nickel oxide has relatively poor structural stability, which causes difficulties in achieving sufficient cycle life characteristics. Meanwhile, lithium manganese oxides exhibit excellent stability but have a disadvantage of relatively low capacity characteristics. In order to address these issues of lithium transition metal oxides including Ni, Co, or Mn alone, lithium composite transition metal oxides including two or more transition metals have been developed, among which lithium nickel cobalt manganese oxide including Ni, Co, and Mn is widely used in the field of batteries for electric vehicles.

Meanwhile, a positive electrode active material using a lithium nickel-based oxide including a high content of nickel has been widely used because excellent capacity and energy density may be implemented. However, due to the high Ni content, severe structural collapse occurs during charging and discharging, and oxygen generated therefrom continuously causes side reactions with an electrolyte, thereby degrading thermal stability and resulting in poor high-temperature characteristics.

To address such problems, a method has been proposed to improve thermal stability and high-temperature characteristics by preparing single-particle-type positive electrode active material particles including a lithium nickel-based oxide having a high Ni content. Nevertheless, it has not been easy to achieve excellent thermal stability and high-temperature characteristics.

In consideration of the above, the present disclosure provides a single-particle-type positive electrode active material including a lithium nickel-based oxide having a high Ni content. Excellent thermal stability and high-temperature characteristics of a lithium secondary battery are implemented by forming a Ti-containing coating layer on a surface of the lithium nickel-based oxide while controlling the TSI value represented by Equation 1 according to the present disclosure to be about 45 or less.

Hereinafter, the present disclosure will be described.

A positive electrode active material according to the present disclosure, and a positive electrode and a lithium secondary battery including the same, include at least one of the configurations disclosed below, and may include any combination of the configurations disclosed below that is technically possible.

### Positive Electrode Active Material

A positive electrode active material according to the present disclosure includes: a lithium nickel-based oxide having a Ni content of about 60 mol % to 80 mol % among total metals excluding lithium; and a coating layer containing Ti and formed on a surface of the lithium nickel-based oxide. The lithium nickel-based oxide is of a single-particle-type including 50 or fewer nodules, and has a thermal stability index (TSI) of about 42.5 or less as represented by Equation 1:

$$Thermal stability index ( TSI ) = HFA \times MPH / ( {T}_{1} - 150 ) \qquad [ Equation 1 ]$$

In Equation 1, HFA, MPH, and T₁ are values measured from a differential scanning calorimetry (DSC) analysis graph obtained by heating a lithium secondary battery fabricated using the positive electrode active material from 25° C. to 400° C. at a heating rate of 10° C./min. HFA is an area value between 150° C. and 350° C. in the DSC analysis graph, MPH is a value of a maximum peak height in the DSC analysis graph, and T₁ is a value of a maximum peak temperature in the DSC analysis graph.

According to an embodiment of the present disclosure, the positive electrode active material according to the present disclosure has the TSI of about 42.5 or less represented by Equation 1, and includes a Ti-containing coating layer formed on a surface of a lithium nickel-based oxide.

$$Thermal stability index ( TSI ) = HFA \times MPH / ( {T}_{1} - 150 ) \qquad [ Equation 1 ]$$

HFA, MPH, and T₁ are values measured from a DSC analysis graph obtained by heating a lithium secondary battery fabricated using the positive electrode active material from 25° C. to 400° C. at a heating rate of 10° C./min. In Equation 1, HFA is an area value between 150° C. and 350° C. in the DSC analysis graph, MPH is a value of a maximum peak height in the DSC analysis graph, and T₁ is a value of a maximum peak temperature in the DSC analysis graph.

The TSI described above is a ratio of a product of an area value and a maximum peak height value to a value obtained by subtracting 150 from a maximum peak temperature value obtained in the DSC analysis graph, and serves as a factor indicating effects of a maximum calorific value, a maximum heat flow per unit weight, and temperature, thereby enabling quantification of thermal stability.

When the TSI represented by Equation 1 exceeds about 42.5, the maximum calorific value or the maximum heat flow per unit weight may be excessively high, or the maximum peak temperature may be excessively low. In addition, even when one or more of the maximum calorific value, the maximum heat flow per unit weight, and the maximum peak temperature satisfy an appropriate range, at least one of the factors may fail to satisfy the appropriate range. In such cases, instantaneous heat flow may not be sufficiently withstood, an excessive calorific value may be generated, or abrupt thermal changes may occur at a low temperature, which may degrade crystalline structural stability of the positive electrode active material and increase side reactions with an electrolyte. As a result, high-temperature stability, high-temperature cycle life characteristics, and high-temperature storage characteristics may be degraded.

According to an embodiment, the TSI represented by Equation 1 may be about 1 to 42.5. For example, the TSI may be about 1 or more, 5 or more, 10 or more, 15 or more, 20 or more, 25 or more, or 30 or more, and may be about 42.5 or less, 40 or less, 39 or less, or 38.7 or less. According to an embodiment, the TSI represented by Equation 1 may be about 30.0 to 38.7. When the TSI satisfies the above-described range, the total calorific value, the maximum peak height, and the maximum peak temperature may be appropriately combined to suppress oxygen release and oxidation reactions, reduce abrupt thermal runaway, and delay structural collapse even at a high temperature. Accordingly, since excellent structural stability and high-temperature stability may be ensured, superior high-temperature cycle life and high-temperature storage characteristics may be achieved.

Meanwhile, even when the above-described TSI range is satisfied, when a coating layer does not include titanium (Ti), excessive local reactivity may occur at a particle surface in direct contact with an electrolyte, and side reactions caused by oxygen release under high-temperature and high-voltage conditions may occur, along with transition metal dissolution problems, which may degrade high-temperature stability, high-temperature cycle life characteristics, and high-temperature storage characteristics. However, when a Ti-containing coating layer, which satisfies the TSI range, is formed, a stable oxide network formed by Ti—O bonds may increase a binding energy of surface oxygen to suppress oxygen release under high-temperature and high-voltage conditions. In addition, the Ti-containing coating layer may perform physical and chemical buffering between the electrolyte and the lithium nickel-based oxide, which may suppress transition metal dissolution and reduce abrupt heat generation and gas generation. Accordingly, excellent high-temperature stability, high-temperature cycle life characteristics, and high-temperature storage characteristics may be achieved.

The TSI represented by Equation 1 may be controlled by various methods. For example, the TSI may be controlled depending on the content of Ni in the lithium nickel-based oxide, whether the lithium nickel-based oxide is of a single-particle-type, types and contents of dopant elements, and types and contents of coating elements. For example, the TSI may be controlled depending on the types and contents of the dopant elements and the types and contents of the coating elements.

According to an embodiment of the present disclosure, the HFA may be about 300 to 475, for example, about 325 to 450, or about 350 to 425. When the HFA satisfies the above-described range, the calorific value may be appropriately controlled to achieve excellent high-temperature stability and high-temperature characteristics.

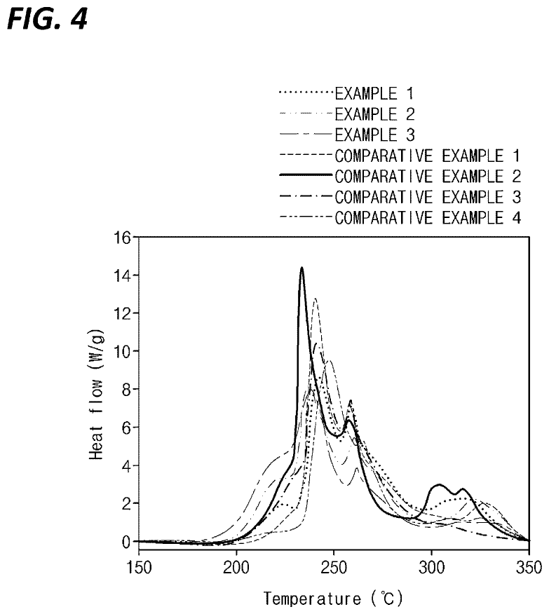

For example, the HFA may be obtained by performing a differential scanning calorimetry (DSC) analysis to be described below, and may be a dimensionless value corresponding to an area between 150° C. and 350° C. in a DSC graph in which the x-axis represents temperature (° C.) and the y-axis represents heat flow (W/g). In addition, as illustrated in FIG. 4, a point at which the heat flow is positive indicates an exothermic reaction, and a point at which the heat flow is negative indicates an endothermic reaction. When an area between 150° C. and 350° C. is measured, an endothermic region is calculated as a negative value and an exothermic region is calculated as a positive value.

According to an embodiment of the present disclosure, the MPH may be about 5 to 15, for example, from about 6 to 14, from about 7 to 12, or from about 7 to 9.4. When the MPH satisfies the above-described range, instantaneous heat flow may be appropriately controlled to achieve excellent high-temperature stability and high-temperature characteristics.

For example, the MPH may be obtained by performing a differential scanning calorimetry (DSC) analysis to be described below, and may be a dimensionless value corresponding to a maximum peak height in a DSC graph in which the x-axis represents temperature (° C.) and the y-axis represents heat flow (W/g).

According to an embodiment of the present disclosure, the T₁ may be about 220 to 260, for example, about 230 to 255, about 236 to 250, or about 240 to 250. When the T₁ satisfies the above-described range, a temperature at which instantaneous heat flow occurs may be appropriately controlled to achieve excellent high-temperature stability and high-temperature characteristics.

For example, the T₁ may be obtained by performing a differential scanning calorimetry (DSC) analysis to be described below, and may be a dimensionless value corresponding to a maximum peak temperature in a DSC graph in which the x-axis represents temperature (° C.) and the y-axis represents heat flow (W/g).

According to an embodiment of the present disclosure, the HFA, the MPH, and the T₁ may be values measured from a differential scanning calorimetry (DSC) analysis graph obtained by heating a lithium secondary battery fabricated using the above-described positive electrode active material from 25° C. to 400° C. at a heating rate of 10° C./min. When the above-described range is satisfied, thermal stability of the lithium nickel-based oxide according to the present disclosure may be more clearly quantified.

Hereinafter, the positive electrode active material according to the present disclosure will be described in more detail.

### (1) Lithium Nickel-Based Oxide

The positive electrode active material according to the present disclosure includes a lithium nickel-based oxide having a Ni content of about 60 mol % to 80% among total metals excluding lithium, and the lithium nickel-based oxide is of a single-particle-type including 50 or fewer nodules.

According to an embodiment of the present disclosure, the positive electrode active material may include a lithium nickel-based oxide having a Ni content of about 60 mol % to 80%, for example, about 65 mol % to 75 mol %, or about 67 mol % to 73 mol %, among total metals excluding lithium. Accordingly, when the above-described range is satisfied, thermal stability, high-temperature cycle life characteristics, and high-temperature storage characteristics may be improved while achieving excellent capacity and energy density characteristics. Meanwhile, when the above-described range is satisfied, excellent capacity and energy density may be achieved due to the high Ni content, but problems such as structural instability and gas generation at a high temperature may be intensified. In this case, such problems may be appropriately mitigated by the above-described TSI range and the Ti-containing coating layer, and the three factors may act in a complementary manner to provide a synergistic effect. As a result, excellent capacity and energy density characteristics may be achieved while excellent high-temperature stability, high-temperature cycle life characteristics, and high-temperature storage characteristics are achieved.

According to an embodiment of the present disclosure, the lithium nickel-based oxide may be represented by Formula 1:

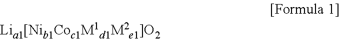

In Formula 1, M¹ is Mn, Al, or a combination thereof, for example, Mn or a combination of Mn and Al.

M² is one or more elements selected from Ti, Mg, Al, Zr, Y, Ba, Ca, Sr, W, Ta, Nb, and Mo, for example, one or more elements selected from Al, Zr, Y, Ti, Sr, and Nb. When the above conditions are satisfied, structural stability of lithium nickel-based oxide particles may be improved so as to achieve more excellent high-temperature cycle life and high-temperature storage characteristics.

The symbol “a1” represents a lithium molar ratio in the lithium nickel-based oxide, and may satisfy 0.80≤a1≤1.20, 0.90≤a1≤1.10, or 1.00≤a1≤1.10. When the above-described range is satisfied, resistance may be decreased while gas generation is reduced.

The symbol “b1” represents a molar ratio of nickel among total metals excluding lithium in the lithium nickel-based oxide, and may satisfy 0.60≤b1≤0.80, 0.65≤b1≤0.75, or 0.67≤b1≤0.73. When the above-described range is satisfied, a high-temperature stability effect according to Equation 1 of the present disclosure may be maximized while excellent capacity characteristics are achieved.

The symbol “c1” represents a molar ratio of cobalt among total metals excluding lithium in the lithium nickel-based oxide, and may satisfy 0<c1≤0.20, 0<c1≤0.15, or 0<c1≤0.10.

The symbol “d1” represents a molar ratio of M¹ among total metals excluding lithium in the lithium nickel-based oxide, and may satisfy 0<d1≤0.40, 0<d1≤0.30, or 0<d1≤0.20.

The symbol “e1” represents a molar ratio of M² among total metals excluding lithium in the lithium nickel-based oxide, and may satisfy 0≤e1≤0.10, 0≤e1≤0.08, or 0≤e1≤0.05.

According to an embodiment, the lithium nickel-based oxide may be represented by Formula 1-1 below.

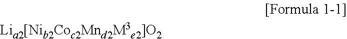

In Formula 1-1, M³ is one or more elements selected from Ti, Mg, Zr, Y, Ba, Ca, Sr, W, Ta, Nb, and Mo, and a2, b2, c2, d2, and e2 satisfy 0.80≤a2≤1.20, 0.67≤b2≤0.73, 0<c2≤0.10, 0<d2≤0.20, and 0≤e2≤0.05.

The lithium nickel-based oxide according to the present disclosure is of a single-particle-type including 50 or fewer nodules. For example, the lithium nickel-based oxide may include 1 to 40 nodules, 1 to 30 nodules, 1 to 25 nodules, or 1 to 15 nodules. A single-particle-type lithium nickel-based oxide, which includes a small number of nodules constituting a particle, has a reduced internal interfacial area within the particle, and thus has a small contact area with an electrolyte. Accordingly, compared to a conventional lithium nickel-based oxide in the form of a secondary particle in which 51 to several hundred primary particles are aggregated, side reactions with the electrolyte are reduced, and gas generation is also significantly reduced. Therefore, when a single-particle-type lithium nickel-based oxide is applied, gas generation may be reduced while excellent high-temperature stability and high-temperature cycle life characteristics are achieved.

Meanwhile, even when a Ti-containing coating layer is formed on a lithium nickel-based oxide while satisfying the above-described TSI range, when the lithium nickel-based oxide is in the form of a secondary particle, a problem may occur in that, as a battery is operated and cycling proceeds, uncoated surface regions significantly increase due to cracks formed inside the particle, and side reactions with an electrolyte increase at the uncoated regions, which may degrade high-temperature stability, high-temperature cycle life characteristics, and high-temperature storage characteristics.

According to an embodiment of the present disclosure, the lithium nickel-based oxide may include, as dopant elements, two or more elements selected from Zr, Y, Al, W, Nb, and Sr. For example, the lithium nickel-based oxide may include two or more elements selected from Zr, Y, Al, and W. When the above conditions are satisfied, excellent high-temperature stability, high-temperature cycle life characteristics, and high-temperature storage characteristics may be achieved while appropriately controlling the above-described TSI range.

According to an embodiment of the present disclosure, the lithium nickel-based oxide includes dopant elements, and a content of the dopant elements may range from about 1,000 ppm to 15,000 ppm, for example, about 2,500 ppm to 12,500 ppm, or about 5,000 ppm to 10,000 ppm, based on a total weight of the positive electrode active material. When the above-described range is satisfied, the aforementioned TSI value may be controlled within an appropriate range, and structural stability of lithium nickel-based oxide particles may be improved. Accordingly, gas generation at a high temperature may be reduced while improving high-temperature cycle life characteristics and high-temperature storage characteristics.

According to an embodiment of the present disclosure, the lithium nickel-based oxide may include, based on the total weight of the positive electrode active material, two or more elements selected from about 500 ppm to 5,000 ppm of Zr, about 500 ppm to 5,000 ppm of Y, about 500 ppm to 5,000 ppm of Al, about 500 ppm to 5,000 ppm of W, about 500 ppm to 5,000 ppm of Nb, and about 500 ppm to 5,000 ppm of Sr. For example, the lithium nickel-based oxide may include two or more elements selected from about 500 ppm to 5,000 ppm of Zr, about 500 ppm to 5,000 ppm of Y, about 500 ppm to 5,000 ppm of Al, and about 500 ppm to 5,000 ppm of W. According to an embodiment, the lithium nickel-based oxide may include, based on the total weight of the positive electrode active material, two or more elements selected from about 1,000 ppm to 4,000 ppm of Zr, about 500 ppm to 3,000 ppm of Y, about 500 ppm to 3,000 ppm of Al, and about 1,000 ppm to 4,000 ppm of W. Alternatively, the lithium nickel-based oxide may include about 1,000 ppm to 4,000 ppm of Zr, about 500 ppm to 3,000 ppm of Y, about 500 ppm to 3,000 ppm of Al, and about 1,000 ppm to 4,000 ppm of W. When the above-described ranges are satisfied, the aforementioned TSI value may be controlled within an appropriate range, structural stability of lithium nickel-based oxide particles may be improved. Accordingly, gas generation at a high temperature may be reduced while high-temperature cycle life characteristics and high-temperature storage characteristics are improved.

### (2) Coating Layer

The positive electrode active material according to the present disclosure includes a Ti-containing coating layer formed on a surface of the lithium nickel-based oxide. When the coating layer is formed on a surface of lithium nickel-based oxide particles, contact between an electrolyte and the lithium nickel-based oxide is suppressed by the coating layer, and thus effects of reducing transition metal dissolution or gas generation caused by side reactions with the electrolyte may be obtained. In addition, the coating layer, which contains titanium (Ti), may exhibit excellent structural stability even in a high-voltage region to enhance oxygen stability and improve structural stability, so that excellent high-temperature characteristics may be achieved.

Meanwhile, as described above, even when the above-described TSI range is satisfied, when a coating layer does not include titanium (Ti), excessive local reactivity may occur at a particle surface in direct contact with an electrolyte, and side reactions caused by oxygen release under high-temperature and high-voltage conditions may occur, along with transition metal dissolution problems, which may degrade high-temperature stability, high-temperature cycle life characteristics, and high-temperature storage characteristics. However, when a Ti-containing coating layer is formed while satisfying the set TSI range, a stable oxide network formed by Ti—O bonds may increase a binding energy of surface oxygen to suppress oxygen release under high-temperature and high-voltage conditions. In addition, the Ti-containing coating layer may perform physical and chemical buffering between the electrolyte and the lithium nickel-based oxide, thereby suppressing transition metal dissolution and simultaneously reducing abrupt heat generation and gas generation. Accordingly, excellent high-temperature stability, high-temperature cycle life characteristics, and high-temperature storage characteristics may be achieved.

According to an embodiment of the present disclosure, the coating layer may further include one or more elements selected from Al and W. For example, the coating layer may further include Al and W. When the above conditions are satisfied, the aforementioned TSI value may be controlled within an appropriate range, output characteristics may be improved, and stability of the coating layer may be reinforced. Accordingly, gas generation at a high temperature may be reduced while high-temperature cycle life characteristics and high-temperature storage characteristics are improved.

According to an embodiment of the present disclosure, the weight of the coating layer may be about 500 ppm to 5,000 ppm based on the total weight of the positive electrode active material. For example, the weight of the coating layer may be about 500 ppm or more, 750 ppm or more, or 1,000 ppm or more, and may be about 5,000 ppm or less, 4,500 ppm or less, 4,000 ppm or less, or 3,500 ppm or less. For example, the weight of the coating layer may be about 1,000 ppm to 3,500 ppm. When the above-described range is satisfied, the aforementioned TSI value may be controlled within an appropriate range, resistance of the positive electrode active material may be reduced while appropriately controlling side reactions with an electrolyte, and gas generation at a high temperature may be reduced while high-temperature cycle life characteristics and high-temperature storage characteristics are improved.

According to an embodiment of the present disclosure, the coating layer may include about 500 ppm to 3,000 ppm of Ti based on the total weight of the positive electrode active material, and the coating layer may further include one or more elements selected from about 500 ppm to 3,000 ppm of Al and about 500 ppm to 3,000 ppm of W based on the total weight of the positive electrode active material. For example, the coating layer may include about 500 ppm to 3,000 ppm of Ti based on the total weight of the positive electrode active material, and may further include about 500 ppm to 3,000 ppm of Al and about 500 ppm to 3,000 ppm of W based on the total weight of the positive electrode active material. When the above conditions are satisfied, the aforementioned TSI value may be controlled within an appropriate range, resistance of the positive electrode active material may be reduced while appropriately controlling side reactions with an electrolyte, and gas generation at a high temperature may be reduced while high-temperature cycle life characteristics and high-temperature storage characteristics are improved.

According to an embodiment of the present disclosure, the positive electrode active material may have an average particle diameter of about 2 μm to 5 μm, for example, about 2.5 μm to 4.7 μm, or about 3.0 μm to 4.5 μm. When the above-described range is satisfied, side reactions with an electrolyte may decrease and gas generation may be reduced while excellent capacity and resistance characteristics are exhibited.

According to an embodiment of the present disclosure, the BET specific surface area of the positive electrode active material may be about 0.3 m²/g to 1.2 m²/g, for example, from about 0.4 m²/g to 1.0 m²/g, or from about 0.5 m²/g to 0.8 m²/g. When the above-described range is satisfied, by reducing a contact area with an electrolyte to reduce interfacial side reactions, gas generation may be reduced while excellent resistance characteristics are achieved.

### Positive Electrode

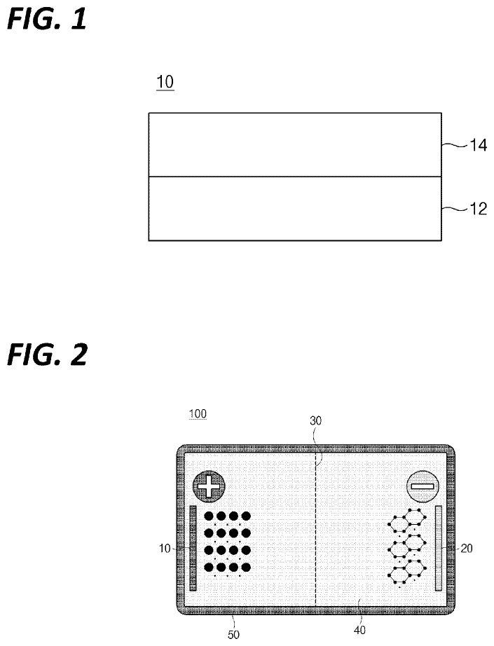

Hereinafter, a positive electrode according to an embodiment of the present disclosure will be described with reference to FIG. 1.

A positive electrode 10 according to an embodiment of the present disclosure includes the above-described positive electrode active material. For example, the positive electrode 10 may include a positive electrode active material layer including the above-described positive electrode active material, and may include a positive electrode current collector 12 and a positive electrode active material layer 14 disposed on the positive electrode current collector and including the above-described positive electrode active material.

Hereinafter, each component of the positive electrode according to the present disclosure will be described in detail.

### (1) Positive Electrode Current Collector

As for the positive electrode current collector 12, various positive electrode current collectors used in the art may be used. For example, the positive electrode current collector 12 may include stainless steel, aluminum, nickel, titanium, calcined carbon, or a surface-treated material in which the surface of aluminum or stainless steel is treated with, for example, carbon, nickel, titanium, or silver. The positive electrode current collector 12 may typically have a thickness of about 3 μm to 500 μm, and a fine uneven structure may be formed on the surface of the positive electrode current collector 12 to improve the adhesion of the positive electrode active material. The positive electrode current collector 12 may be used in various forms such as a film, a sheet, a foil, a net, a porous body, a foam, or a nonwoven fabric.

### (2) Positive Electrode Active Material Layer

The positive electrode active material layer 14 may be disposed on the positive electrode current collector 12 and may be positioned, for example, on one surface or both surfaces of the positive electrode current collector 12. The positive electrode active material layer 14 may have a single-layer or multilayer structure of two or more layers.

The positive electrode active material layer 14 may include the positive electrode active material according to the present disclosure, a positive electrode conductive agent, and a positive electrode binder.

The positive electrode active material may be included in an amount of about 90 wt % to 99 wt %, for example, about 92 wt % to 98 wt %, or about 94 wt % to 98 wt %, based on the total weight of the positive electrode active material. When the above range is satisfied, the energy density and capacity characteristics of the lithium secondary battery to which the positive electrode is applied may be improved.

The positive electrode conductive agent is used to impart electrical conductivity to the electrode and may be used without particular limitation as long as it exhibits electronic conductivity without causing a chemical change in the battery. Specific examples of the positive electrode conductive agent may include: graphite such as natural graphite or artificial graphite; carbon-based materials such as carbon black, acetylene black, Ketjen black, channel black, furnace black, lamp black, thermal black, carbon fibers, or carbon nanotubes; metal powders or metal fibers of, for example, copper, nickel, aluminum, or silver; conductive whiskers of, for example, zinc oxide or potassium titanate; conductive metal oxides such as titanium oxide; or conductive polymers such as polyphenylene derivatives, which may be used either alone or in combination of two or more thereof. The positive electrode conductive agent may typically be included in an amount of about 0.1 wt % to 10 wt %, for example, about 0.1 wt % to 8 wt %, or about 0.1 wt % to 5 wt %, based on the total weight of the positive electrode active material layer.

The positive electrode binder serves to enhance adhesion between particles of the positive electrode material and between the positive electrode material and the positive electrode current collector. Examples thereof may include: fluororesin-based binders such as polyvinylidene fluoride (PVDF) or polytetrafluoroethylene (PTFE); rubber-based binders such as styrene-butadiene rubber (SBR), acrylonitrile-butadiene rubber, or styrene-isoprene rubber; cellulose-based binders such as carboxymethyl cellulose (CMC), starch, hydroxypropyl cellulose, or regenerated cellulose; polyalcohol-based binders such as polyvinyl alcohol; polyolefin-based binders such as polyethylene or polypropylene; polyimide-based binders; polyester-based binders; and silane-based binders, which may be used either alone or in combination of two or more thereof. The positive electrode binder may be included in an amount of about 1 wt % to 10 wt %, for example, about 0.5 wt % to 10 wt %, or about 1 wt % to 8 wt %, based on the total weight of the positive electrode active material layer.

The positive electrode may be prepared by a method known in the relevant technical field. For example, the positive electrode may be prepared by preparing a positive electrode slurry by mixing a positive electrode active material, a positive electrode binder, and a positive electrode conductive agent in a solvent, coating the positive electrode slurry onto a positive electrode current collector, and drying and rolling the coated layer. Alternatively, the positive electrode 10 may be prepared by casting the positive electrode slurry onto a separate support, peeling off the resulting film from the support, and laminating the film obtained thereby onto the positive electrode current collector. As for the solvent of the positive electrode slurry, solvents generally used for positive electrode slurries in the relevant technical field may be used. For example, dimethyl sulfoxide (DMSO), isopropyl alcohol, N-methyl-2-pyrrolidone (NMP), acetone, water, or a mixture thereof may be used, but the present disclosure is not limited thereto. The solvent may be used in an amount sufficient to dissolve or disperse the positive electrode active material, the positive electrode conductive agent, and the positive electrode binder, and to provide a viscosity suitable for uniform coating of the positive electrode slurry.

### Lithium Secondary Battery

Next, referring to FIG. 2, a lithium secondary battery according to an embodiment of the present disclosure will be described.

A lithium secondary battery 100 according to the present disclosure includes a positive electrode 10 according to the present disclosure, a negative electrode 20 disposed to face the positive electrode 10, and an electrolyte. Optionally, the lithium secondary battery 100 according to the present disclosure may further include a separator 30 interposed between the positive electrode 10 and the negative electrode 20.

Since the positive electrode 10 is substantially the same as described above, descriptions of the remaining components other than the positive electrode 10 will be provided below.

### (1) Negative Electrode

In the lithium secondary battery 100 according to the present disclosure, the negative electrode 20 may include a negative electrode active material layer including a negative electrode active material. Specifically, the negative electrode 20 may include a negative electrode current collector and a negative electrode active material layer disposed on at least one surface of the negative electrode current collector.

The negative electrode current collector is not particularly limited as long as it has high conductivity and does not cause a chemical change in the battery. For example, copper, stainless steel, aluminum, nickel, titanium, calcined carbon, a material prepared by surface-treating the surface of copper or stainless steel with, for example, carbon, nickel, titanium, or silver, or an aluminum-cadmium alloy may be used. In addition, the negative electrode current collector may typically have a thickness of about 3 μm to 500 μm. Similarly to the positive electrode current collector, a fine uneven pattern may be formed on the surface of the current collector to enhance the adhesion strength of the negative electrode active material. For example, the negative electrode current collector may be used in various forms such as a film, a sheet, a foil, a net, a porous material, a foam, and a nonwoven fabric.

The negative electrode active material layer may be positioned on the negative electrode current collector. For example, the negative electrode active material layer may be positioned, on one surface or both surfaces of the negative electrode current collector. The negative electrode active material layer may have a single-layer structure or a multilayer structure including two or more layers.

When the negative electrode active material layer has a multilayer structure including two or more layers, respective layers may differ from each other in terms of the type and/or content of the negative electrode active material, negative electrode binder, and/or negative electrode conductive agent. By forming the negative electrode active material layer as a multilayer structure and making the compositions of respective layers differ from each other, the performance characteristics of the battery, such as rapid charging performance and output characteristics, may be appropriately adjusted.

Meanwhile, as the negative electrode active material, a compound capable of reversibly intercalating and deintercalating lithium may be used. Specific examples of the negative electrode active material may include: carbon-based materials such as artificial graphite, natural graphite, graphitized carbon fiber, and amorphous carbon; metallic compounds capable of alloying with lithium, such as Si, Al, Sn, Pb, Zn, Bi, In, Mg, Ga, Cd, Si alloys, Sn alloys, or Al alloys; metal oxides capable of intercalating and deintercalating the lithium ions, such as SiO_{β} (0<β<2), SnO₂, vanadium oxides, and lithium vanadium oxides; or composites including the above-described metallic compounds and carbon-based materials, such as Si—C composites or Sn—C composites, which may be used either alone or in combination of two or more thereof.

Meanwhile, as for the carbon-based material, both low-crystallinity carbon and high-crystallinity carbon may be used. Representative examples of low-crystallinity carbon include soft carbon and hard carbon, and representative examples of high-crystallinity carbon include high-temperature-calcined carbon, such as amorphous carbon, plate-shaped, flake-shaped, spherical, or fibrous natural graphite or artificial graphite, kish graphite, pyrolytic carbon, mesophase pitch-based carbon fibers, meso-carbon microbeads, mesophase pitches, and petroleum or coal tar pitch-derived cokes.

For example, the negative electrode active material may be a carbon-based negative electrode active material. In this case, the carbon-based negative electrode active material may include, for example, natural graphite, artificial graphite, graphitized carbon fiber, amorphous carbon, soft carbon, hard carbon, or a combination thereof. According to an embodiment, the carbon-based negative electrode active material may include natural graphite and artificial graphite.

The carbon-based negative electrode active material may have an average particle diameter (D₅₀) of about 0.1 μm to 30 μm, for example, about 0.5 μm to 30 μm.

The negative electrode active material may be included in an amount of about 80 wt % to 98 wt %, for example, about 90 wt % to 98 wt %, or about 93 wt % to 98 wt %, based on the total weight of the negative electrode active material layer. When the content of the negative electrode active material satisfies the above range, excellent energy density may be achieved.

The negative electrode active material layer may further include a negative electrode conductive agent and/or a negative electrode binder together with the negative electrode active material.

The negative electrode conductive agent is used to impart electrical conductivity to the negative electrode and may be used without particular limitation as long as it exhibits electronic conductivity without causing a chemical change in the battery. Examples of the negative electrode conductive agent may include: carbon-based materials such as carbon black, acetylene black, Ketjen black, channel black, furnace black, lamp black, thermal black, carbon fibers, and carbon nanotubes; metal powders or metal fibers of, for example, copper, nickel, aluminum, or silver; conductive whiskers of, for example, zinc oxide or potassium titanate; conductive metal oxides such as titanium oxide; and conductive polymers such as polyphenylene derivatives, which may be used either alone or in combination of two or more thereof.

The negative electrode conductive agent may be typically included in an amount of about 0.1 wt % to 10 wt %, for example, about 0.1 wt % to 8 wt %, or about 0.1 wt % to 5 wt %, based on the total weight of the negative electrode active material layer.

The negative electrode binder serves to enhance adhesion between negative electrode active material particles and between the negative electrode active material and the negative electrode current collector. Examples of the negative electrode binder may include: polyvinylidene fluoride (PVDF); vinylidene fluoride-hexafluoropropylene copolymer (PVDF-co-HFP); polyvinyl alcohol; polyacrylonitrile; carboxymethyl cellulose (CMC); starch; hydroxypropyl cellulose; regenerated cellulose; polyvinylpyrrolidone; polytetrafluoroethylene; polyethylene; polypropylene; ethylene-propylene-diene monomer rubber (EPDM rubber); sulfonated-EPDM; styrene-butadiene rubber (SBR); fluororubber; or various copolymers thereof, which may be used either alone or in combination of two or more thereof.

The negative electrode binder may be included in an amount of about 0.1 wt % to 10 wt %, for example, about 0.5 wt % to 10 wt %, or about 1 wt % to 8 wt %, based on the total weight of the negative electrode active material layer.

The negative electrode 20 may be prepared by a method known in the art. For example, the negative electrode 20 may be prepared by preparing a negative electrode slurry by mixing a negative electrode active material, a negative electrode binder, and a negative electrode conductive agent in a solvent, coating the negative electrode slurry onto a negative electrode current collector, and drying and rolling the coated layer. Alternatively, the negative electrode 20 may be prepared by casting the negative electrode slurry onto a separate support, peeling off the resulting film from the support, and laminating the film obtained thereby onto the negative electrode current collector.

As for the solvent for the negative electrode slurry, solvents generally used in the relevant technical field may be used. For example, dimethyl sulfoxide (DMSO), isopropyl alcohol, N-methyl-2-pyrrolidone (NMP), acetone, water, or a mixture thereof may be used, but the present disclosure is not limited thereto. The solvent may be used in an amount sufficient to dissolve or disperse the negative electrode active material, the negative electrode conductive agent, and the negative electrode binder, and to provide a viscosity suitable for uniform coating of the negative electrode slurry.

### (2) Electrolyte

The electrolyte 40 according to the present disclosure may include a lithium salt and an organic solvent.

The lithium salt may be used without particular limitation as long as it is a compound capable of providing lithium ions used in a lithium secondary battery 100. For example, as the lithium salt, LiPF₆, LiClO₄, LiAsF₆, LiBF₄, LiSbF₆, LiAlO₄, LiAlCl₄, LiCF₃SO₃, LiCAF₉SO₃, LiN(C₂F₅SO₃)₂, LiN(C₂F₅SO₂)₂, LiN(CF₃SO₂)₂, LiCl, LiI, or LiB(C₂O₄)₂ may be used. The concentration of the lithium salt may be about 0.1 M to 5.0 M, or about 0.1 M to 3.0 M. When the concentration of the lithium salt is within the above range, the electrolyte has appropriate conductivity and viscosity. Therefore, the electrolyte may exhibit excellent electrolyte performance, and lithium ions may effectively migrate.

The organic solvent may include at least one selected from a cyclic carbonate-based organic solvent, a linear carbonate-based organic solvent, a linear ester-based organic solvent, and a cyclic ester-based organic solvent.

The cyclic carbonate-based organic solvent is a high-viscosity organic solvent, and representative examples thereof may include, at least one organic solvent selected from ethylene carbonate (EC), propylene carbonate (PC), 1,2-butylene carbonate, 2,3-butylene carbonate, 1,2-pentylene carbonate, 2,3-pentylene carbonate, and vinylene carbonate.

In addition, the linear carbonate-based organic solvent is a low-viscosity and low-dielectric-constant organic solvent, and representative examples thereof may include at least one organic solvent selected from dimethyl carbonate (DMC), diethyl carbonate (DEC), dipropyl carbonate, ethyl methyl carbonate (EMC), methyl propyl carbonate, and ethyl propyl carbonate. For example, the linear carbonate-based organic solvent may include ethyl methyl carbonate (EMC).

The linear ester-based organic solvent may include at least one organic solvent selected from methyl acetate, ethyl acetate, propyl acetate, methyl propionate, ethyl propionate, propyl propionate, and butyl propionate.

The cyclic ester-based organic solvent may include at least one organic solvent selected from butyrolactone, valerolactone, and caprolactone.

According to an embodiment, the electrolyte according to the present disclosure may include ethylene carbonate and dimethyl carbonate as the organic solvent.

Meanwhile, the electrolyte may further include other additives in addition to the above-described electrolyte components for the purpose of improving cycle life characteristics of a battery, suppressing capacity reduction, and enhancing discharge capacity.

Such other additives may include, as representative examples, at least one selected from cyclic carbonate-based compounds, halogen-substituted carbonate compounds, sulfone-based compounds, sulfate-based compounds, borate-based compounds, nitrile-based compounds, benzene-based compounds, amine-based compounds, silane-based compounds, and lithium salt-based compounds different from the lithium salt included in the electrolyte.

The other additives may include one or more compounds selected from vinylene carbonate (VC), vinyl ethylene carbonate, fluoroethylene carbonate (FEC), 1,3-propane sultone (PS), 1,4-butane sultone, ethenesultone, 1,3-propene sultone (PRS), 1,4-butene sultone, 1-methyl-1,3-propene sultone, ethylene sulfate (Esa), trimethylene sulfate (TMS), methyl trimethylene sulfate (MTMS), tetraphenylborate, lithium oxalyldifluoroborate, succinonitrile, adiponitrile, acetonitrile, propionitrile, butyronitrile, valeronitrile, caprylonitrile, heptanenitrile, cyclopentane carbonitrile, cyclohexane carbonitrile, 2-fluorobenzonitrile, 4-fluorobenzonitrile, difluorobenzonitrile, trifluorobenzonitrile, phenylacetonitrile, 2-fluorophenylacetonitrile, 4-fluorophenylacetonitrile, fluorobenzene, triethanolamine, ethylenediamine, tetravinylsilane, lithium bis(fluorosulfonyl)imide (LiFSI), lithium bis(trifluoromethane sulfonyl)imide (LiTFSI), LiPO₂F₂, LiODFB, lithium bis(oxalato)borate (LiB(C₂O₄)₂; LiBOB), and LiBF₄.

The other additives may be included in an amount of about 0.01 wt % to 20 wt %, for example, about 0.05 wt % to 5.0 wt %, based on the total weight of the electrolyte.

### (3) Separator

The separator 30 physically separates a negative electrode 20 and a positive electrode 10 and provides a path for lithium-ion migration, and any separator commonly used in lithium secondary batteries may be used without particular limitation. The separator 30 may be interposed between the positive electrode 10 and the negative electrode 20.

According to an embodiment, as the separator 30, a porous polymer film made of a polyolefin-based polymer, such as an ethylene homopolymer, a propylene homopolymer, an ethylene/butene copolymer, an ethylene/hexene copolymer, or an ethylene/methacrylate copolymer, or a laminated structure including two or more layers thereof, may be used. In addition, conventional porous nonwoven fabrics such as nonwoven fabrics made of, for example, high-melting-point glass fibers or polyethylene terephthalate fibers may be used. In addition, a coated separator including a ceramic component or a polymer material to ensure heat resistance or mechanical strength may be used, and may optionally be used in a single-layer or multilayer structure.

The lithium secondary battery 100 according to the present disclosure may be advantageously applied to portable devices such as mobile phones, laptop computers, and digital cameras, as well as to electric vehicle fields such as hybrid electric vehicles (HEVs). The lithium secondary battery according to the present disclosure, which may exhibit excellent output characteristics even under low-temperature conditions, may be particularly useful in the field of electric vehicles.

According to another embodiment of the present disclosure, a battery module including the lithium secondary battery according to the present disclosure as a unit cell and a battery pack including the same are provided.

The battery module or the battery pack may be used as a power source for one or more medium- or large-sized devices such as power tools, electric vehicles (EVs) including hybrid electric vehicles (HEVs) and plug-in hybrid electric vehicles (PHEVs), or power storage systems.

Hereinafter, the present disclosure will be described in more detail with reference to examples. However, the following examples are provided only to enable those skilled in the art to fully understand and easily implement the present disclosure, and the scope of the present disclosure is not limited to the following examples.

### Example 1

A single-particle-type lithium nickel-based oxide internally doped with Zr, Y, Al, and W was prepared by mixing Ni_{0.7}Co_{0.1}Mn_{0.2}(OH)₂ as a precursor and Li₂CO₃ as a lithium source material with ZrO₂, Y₂O₃, Al₂O₃, and WO₃ as doping source materials, followed by calcination of the resulting mixture at 950° C. for 12 hours.

Thereafter, the lithium nickel-based oxide was mixed with TiO₂, Al₂O₃, and WO₃ as coating source materials, followed by heat treatment at 450° C. for 6 hours to prepare a positive electrode active material including a coating layer formed on a surface of the lithium nickel-based oxide and including Ti, Al, and W.

At this time, the types and contents of the respective dopant elements and the types and contents of the coating elements were as shown in Table 1 below, based on the total weight of the positive electrode active material.

Subsequently, using the positive electrode active material prepared through the above process, a lithium secondary battery, for example, a coin half-cell, was fabricated and charged. Thereafter, a positive electrode was separated from the charged coin half-cell, placed into a pan for DSC measurement, injected with an electrolyte, and sealed to prepare a DSC measurement sample. A TSI value was then obtained by performing DSC analysis to obtain, for example, heat flow values.

In the present example, a secondary battery such as a coin half-cell was first fabricated for DSC analysis. However, depending on circumstances or requirements, DSC analysis may also be performed without fabricating a secondary battery, for example, by preparing only a positive electrode and conducting DSC analysis thereon.

### Example 2

A positive electrode active material was prepared in the same manner as in Example 1, except that the types and contents of the dopant elements and the types and contents of the coating elements were controlled as shown in Table 1 below.

### Example 3

A positive electrode active material was prepared in the same manner as in Example 1, except that the types and contents of the dopant elements and the types and contents of the coating elements were controlled as shown in Table 1 below.

### Comparative Example 1

A positive electrode active material was prepared in the same manner as in Example 1, except that the types and contents of the dopant elements and the types and contents of the coating elements were controlled as shown in Table 1 below.

### Comparative Example 2

A positive electrode active material was prepared in the same manner as in Example 1, except that the types and contents of the dopant elements and the types and contents of the coating elements were controlled as shown in Table 1 below.

### Comparative Example 3

A positive electrode active material was prepared in the same manner as in Example 1, except that the types and contents of the dopant elements and the types and contents of the coating elements were controlled as shown in Table 1 below.

### Comparative Example 4

A lithium nickel-based oxide in the form of secondary particles internally doped with Zr and Y was prepared by mixing Ni_{0.7}Co_{0.1}Mn_{0.2}(OH)₂ as a precursor and Li₂CO₃ as a lithium source material with ZrO₂ and Y₂O₃ as doping source materials, followed by calcination of the resulting mixture at 800° C. for 12 hours.

Thereafter, the lithium nickel-based oxide was mixed with Al₂O₃ and WO₃ as coating source materials, followed by heat treatment at 450° C. for 6 hours to prepare a positive electrode active material including a coating layer formed on a surface of the lithium nickel-based oxide and including Al and W.

At this time, the types and contents of the respective dopant elements and the types and contents of the coating elements were as shown in Table 1 below, based on the total weight of the positive electrode active material.

TABLE 1

| | | | Dopant | | Coating | |
|---|---|---|---|---|---|---|
| | Particle | | element | | element | |
| | type | Precursor composition | Type | Content | Type | Content |
| Example 1 | Single | Ni_{0.7}Co_{0.1}Mn_{0.2}(OH)₂ | Zr | 3,000 | Ti | 1,000 |
| | particle | | | ppm | | ppm |
| | | | Y | 2,000 | Al | 1,500 |
| | | | | ppm | | ppm |
| | | | Al | 2,000 | W | 1,000 |
| | | | | ppm | | ppm |
| | | | W | 3,000 | — | — |
| | | | | ppm | | |
| Example 2 | Single | Ni_{0.7}Co_{0.1}Mn_{0.2}(OH)₂ | Zr | 2,000 | Ti | 1,500 |
| | particle | | | ppm | | ppm |
| | | | Al | 2,000 | Al | 1,000 |
| | | | | ppm | | ppm |
| | | | W | 2,000 | W | 1,000 |
| | | | | ppm | | ppm |
| Example 3 | Single | Ni_{0.7}Co_{0.1}Mn_{0.2}(OH)₂ | Zr | 1,500 | Ti | 1,000 |
| | particle | | | ppm | | ppm |
| | | | Al | 2,000 | Al | 1,000 |
| | | | | ppm | | ppm |
| | | | W | 4,000 | W | 3,000 |
| | | | | ppm | | ppm |
| | | | Nb | 1,000 | — | — |
| | | | | ppm | | |
| Comparative | Single | Ni_{0.7}Co_{0.1}Mn_{0.2}(OH)₂ | Zr | 3,000 | — | — |
| Example 1 | particle | | | ppm | | |
| | | | Al | 1,000 | — | — |
| | | | | ppm | | |
| Comparative | Single | Ni_{0.7}Co_{0.1}Mn_{0.2}(OH)₂ | — | — | Al | 1,000 |
| Example 2 | particle | | | | | ppm |
| | | | — | — | W | 1,000 |
| | | | | | | ppm |
| Comparative | Single | Ni_{0.7}Co_{0.1}Mn_{0.2}(OH)₂ | Zr | 3,000 | Al | 1,500 |
| Example 3 | particle | | | ppm | | ppm |
| | | | Y | 1,500 | W | 3,000 |
| | | | | ppm | | ppm |
| Comparative | Secondary | Ni_{0.7}Co_{0.1}Mn_{0.2}(OH)₂ | Zr | 3,000 | Al | 1,500 |
| Example 4 | particle | | | ppm | | ppm |
| | | | Y | 1,500 | W | 3,000 |
| | | | | ppm | | ppm |

### Experimental Example 1: Measurement of Average Particle Diameter of Positive Electrode Active Material and Differential Scanning Calorimetry (DSC)

### 1) Measurement of Average Particle Diameter of Positive Electrode Active Material

For each of the positive electrode active materials prepared in Examples 1 to 3 and Comparative Examples 1 to 4, 0.03 g of each positive electrode active material in powder form was dispersed in a dispersion medium, introduced into a laser diffraction particle size analyzer (Microtrac MT 3000), and irradiated with ultrasonic waves at a frequency of about 28 kHz and an output of 60 W to measure an average particle diameter of each positive electrode active material.

The measurement results are shown in Table 2 below.

2) Differential Scanning calorimetry (DSC) Analysis

### (Fabrication of Coin Half-Cells)

The positive electrode active material according to each of Examples 1 to 3 and Comparative Examples 1 to 4, carbon black as a conductive agent, and polyvinylidene fluoride (PVdF) as a binder were mixed in N-methyl-2-pyrrolidone (NMP) at a weight ratio of 96:1:3 to prepare a positive electrode slurry. The positive electrode slurry was coated on one surface of an aluminum current collector, dried, and then roll-pressed to prepare respective positive electrodes.

Lithium (Li) metal was used as a negative electrode.

A porous polyethylene separator was interposed between the positive electrode and the negative electrode to prepare an electrode assembly. The electrode assembly was placed inside a battery case, and an electrolyte was injected into the battery case to fabricate a coin half-cell. The electrolyte was prepared by dissolving 1 M LiPF₆ in a mixed organic solvent including ethylene carbonate (EC), dimethyl carbonate (DMC), and ethyl methyl carbonate (EMC) mixed at a volume ratio of 30:40:30.

(Differential Scanning calorimetry (DSC) Analysis)

Each of the fabricated coin half-cells was charged to 4.45 V in a constant-current mode at 0.2 C.

Thereafter, a positive electrode was separated from each of the charged coin half-cells, placed into a cylindrical pan for DSC measurement, injected with 20 μL of the electrolyte and sealed to prepare a DSC measurement sample.

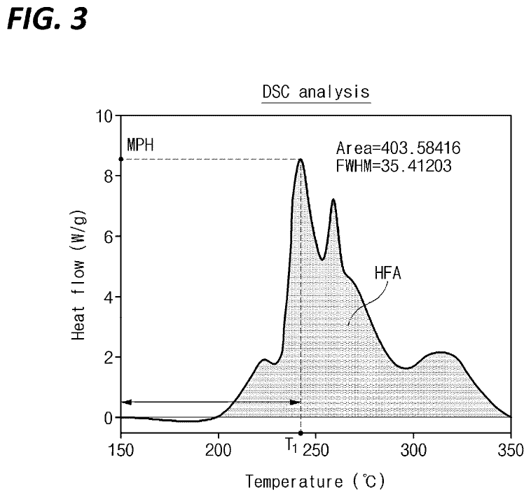

Subsequently, the DSC measurement sample was placed in a heating chamber, and a heat flow was measured as a function of temperature using a differential scanning calorimeter (DSC) while heating from 25° C. to 400° C. at a heating rate of 10° C./min. FIGS. 3 and 4 illustrate graphs of the DSC analysis and results.

From the differential scanning calorimetry (DSC) graphs obtained from FIGS. 3 and 4, the aforementioned HFA, MPH, and T1 were obtained, and a TSI represented by Equation 1 described above was calculated and shown in Table 2.

### Experimental Example 2: Evaluation of High-Temperature Cycle Life Characteristics

The positive electrode active material according to each of Examples 1 to 3 and Comparative Examples 1 to 4, carbon black as a conductive agent, and polyvinylidene fluoride (PVdF) as a binder were mixed in N-methyl-2-pyrrolidone (NMP) at a weight ratio of 96:1:3 to prepare a positive electrode slurry. The positive electrode slurry was coated on one surface of an aluminum current collector, dried, and then roll-pressed to prepare respective positive electrodes.

As a negative electrode active material, mixed graphite obtained by mixing natural graphite and artificial graphite at a weight ratio of 50:50 was used. A negative electrode slurry was prepared by mixing the mixed graphite, carbon nanotubes as a conductive agent, and styrene-butadiene rubber (SBR) as a binder in water at a weight ratio of 95.5:1:3.5. The negative electrode slurry was coated on one surface of a copper current collector, dried, and roll-pressed to prepare a negative electrode.

A porous polyethylene separator was interposed between the positive electrode and the negative electrode to prepare an electrode assembly. Then, the electrode assembly was placed inside a battery case, and an electrolyte was injected into the battery case to fabricate a coin half-cell. The electrolyte was prepared by dissolving 1.2 M LiPF₆ in a mixed organic solvent obtained by mixing ethylene carbonate (EC), ethyl methyl carbonate (EMC), and dimethyl carbonate (DMC) at a volume ratio of 20:70:10.

Thereafter, charging was performed to 4.4 V at a constant current of 0.33 C at a temperature of 45° C., and discharging was performed to 2.5 V at 0.33 C, with one charge-discharge operation defined as one cycle. After one cycle, an initial discharge capacity and an initial resistance were measured, and a discharge capacity and a resistance were measured while repeating the same charge-discharge operation up to 300 cycles.

Based on these measurements, a capacity retention ratio relative to the initial discharge capacity and a resistance increase ratio relative to the initial resistance were calculated.

The measurement results are shown in Table 2 below.

### Experimental Example 3: Evaluation of High-Temperature Storage Characteristics

For the lithium secondary batteries according to Examples 1 to 3 and Comparative Examples 1 to 4 prepared in Experimental Example 2, charging was performed to 4.4 V at a constant current of 0.33 C at a temperature of 25° C., and the lithium secondary batteries were disassembled to separate positive electrodes.

Thereafter, the separated positive electrodes and 400 μL of an electrolyte were placed in pouch-type battery cases and sealed to fabricate cells, and a change in cell volume (ΔCell volume, unit: μL) before and after the high-temperature storage was measured while the cells were stored at 65° C. for 8 weeks. The cell volume change was measured by a method of immersing each cell in water and measuring a change in the volume of the water.

The measurement results are shown in Table 2 below.

TABLE 2

| | | | | | | High-temperature cycle | | |
|---|---|---|---|---|---|---|---|---|
| | Average | | | | | life characteristics | | High-temperature |
| | particle | Differential scanning | | | | (300 cycles) | | storage |
| | diameter | calorimetry (DSC) analysis | | | | Capacity | Resistance | characteristics |
| | (μm) | HFA | MPH | T₁ | TSI | retention ratio | increase ratio | Cell volume change |
| Example 1 | 4.00 | 403.5 | 8.8 | 241.7 | 38.7 | 87.1 | 67.2 | 351 |
| Example 2 | 3.70 | 413.7 | 8.2 | 236.9 | 39.0 | 85.7 | 91.5 | 476 |
| Example 3 | 3.70 | 383.8 | 8.2 | 239.4 | 35.2 | 87.3 | 65.3 | 336 |
| Comparative | 3.67 | 412.0 | 13.0 | 240.3 | 59.3 | 76.4 | 125.5 | 794 |
| Example 1 | | | | | | | | |
| Comparative | 3.84 | 448.7 | 14.5 | 233.1 | 78.3 | 78.3 | 156.4 | 830 |
| Example 2 | | | | | | | | |
| Comparative | 3.76 | 376.1 | 10.4 | 241.1 | 42.9 | 80.2 | 94.2 | 635 |
| Example 3 | | | | | | | | |
| Comparative | 7.18 | 321.9 | 9.5 | 235.1 | 36.0 | 81.1 | 53.9 | 579 |
| Example 4 | | | | | | | | |

As shown in Table 2, in the cases of Examples 1 to 3, the TSI values were maintained at 38.7, 39.0, and 35.2, respectively, which are values of 45 or less, whereas in the cases of Comparative Examples 1 to 4, the TSI values were 45 or greater.

In the cases of Examples 1 to 3, both the high-temperature cycle life characteristics, as represented by the capacity retention ratio and the resistance increase ratio, and the high-temperature storage characteristics, as represented by the cell volume change, are superior compared to those of Comparative Examples 1 to 4.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A positive electrode active material comprising:
a lithium nickel-based oxide having a nickel (Ni) content of about 60 mol % to 80 mol % among total metals excluding lithium; and
a coating layer containing titanium (Ti) and formed on a surface of the lithium nickel-based oxide,
wherein the lithium nickel-based oxide is of a single-particle-type including 50 or fewer nodules, and has a thermal stability index (TSI) of about 42.5 or less as represented by Equation 1:
$$Thermal stability index ( TSI ) = HFA \times MPH / ( {T}_{1} - 150 ) \qquad [ Equation 1 ]$$
wherein, HFA, MPH, and T₁ are values measured from a differential scanning calorimetry (DSC) analysis graph obtained by heating a lithium secondary battery fabricated using the positive electrode active material from 25° C. to 400° C. at a heating rate of 10° C./min,
HFA is an area value between 150° C. and 350° C. in the DSC analysis graph,
MPH is a value of a maximum peak height in the DSC analysis graph, and
T₁ is a value of a maximum peak temperature in the DSC analysis graph.

2. The positive electrode active material according to claim 1, wherein the thermal stability index (TSI) represented by Equation 1 is about 30.0 to 38.7.

3. The positive electrode active material according to claim 1, wherein HFA in Equation 1 is about 300 to 475.

4. The positive electrode active material according to claim 1, wherein MPH in Equation 1 is about 5 to 15.

5. The positive electrode active material according to claim 1, wherein T₁ in Equation 1 is about 220 to 260.

6. The positive electrode active material according to claim 1, wherein the lithium nickel-based oxide is represented by Formula 1: 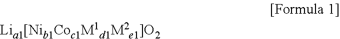
wherein, M¹ is Mn, Al, or a combination thereof, M² includes one or more elements selected from Ti, Mg, Al, Zr, Y, Ba, Ca, Sr, W, Ta, Nb, and Mo, and a1, b1, c1, d1, and e1 satisfy 0.80≤a1≤1.20, 0.60≤b1≤0.80, 0<c1≤0.20, 0<d1≤0.40, and 0≤e1≤0.10.

7. The positive electrode active material according to claim 1, wherein the lithium nickel-based oxide includes, as dopant elements, two or more elements selected from Zr, Y, Al, W, Nb, and Sr.

8. The positive electrode active material according to claim 1, wherein the lithium nickel-based oxide includes dopant elements, and
a content of the dopant elements is about 1,000 ppm to 15,000 ppm based on a total weight of the positive electrode active material.

9. The positive electrode active material according to claim 1, wherein the lithium nickel-based oxide includes, as dopant elements, two or more selected from Zr, Y, Al, W, Nb, and Sr, each of the dopant elements being included in an amount of about 500 ppm to 5,000 ppm based on a total weight of the positive electrode active material.

10. The positive electrode active material according to claim 1, wherein the coating layer further includes one or more elements selected from Al and W.

11. The positive electrode active material according to claim 1, wherein the coating layer has a weight of about 2,000 ppm to 5,000 ppm based on a total weight of the positive electrode active material.

12. The positive electrode active material according to claim 1, wherein the coating layer includes about 500 ppm to 3,000 ppm of titanium (Ti) based on a total weight of the positive electrode active material, and
the coating layer further includes one or more elements selected from about 500 ppm to 3,000 ppm of aluminum (Al) and about 500 ppm to 3,000 ppm of tungsten (W) based on the total weight of the positive electrode active material.

13. The positive electrode active material according to claim 1, wherein the positive electrode active material has an average particle diameter of about 2 μm to 5 μm.

14. A positive electrode comprising the positive electrode active material according to claim 1.

15. A lithium secondary battery comprising:
the positive electrode according to claim 14;
a negative electrode disposed to face the positive electrode, and
an electrolyte.
